(19) United States
(12) Patent Application Publication
(10) Pub. No.: US 2024/0088388 A1
(43) Pub. Date: Mar. 14, 2024

(54) PREPARATION METHOD OF HARD CARBON ANODE MATERIAL AND USE THEREOF

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Foshan, Guangdong (CN); HUNAN BRUNP EV RECYCLING CO., LTD., Changsha, Hunan (CN)

(72) Inventors: Shuang ZHENG, Foshan, Guangdong (CN); Changdong LI, Foshan, Guangdong (CN); Linlin MAO, Foshan, Guangdong (CN); Dingshan RUAN, Foshan, Guangdong (CN)

(73) Assignees: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING CO., LTD., Changsha, Hunan (CN)

(21) Appl. No.: 18/284,763

(22) PCT Filed: Nov. 11, 2022
(86) PCT No.: PCT/CN2022/131441

§ 371 Date: Sep. 28, 2023

(30) Foreign Application Priority Data
Mar. 15, 2022 (CN) 202210253128.3

(51) Int. Cl. H01M 4/587; C01B 32/05; H01M 10/054

(52) U.S. Cl. CPC H01M 4/587; C01B 32/05; H01M 10/054; C01P 2002/72; C01P 2004/03; C01P 2004/61; C01P 2006/13; C01P 2006/40; H01M 2004/027

(57) ABSTRACT

The disclosure belongs to the technical field of sodium ion battery materials, and discloses a preparation method of a hard carbon anode material and use thereof. The preparation method includes the following steps of: performing first sintering on starch, crushing, and introducing air and nitrogen for secondary sintering to obtain porous hard block granules; and performing third sintering on the porous hard block granules, and then continuously warming up to perform fourth sintering to obtain the hard carbon anode material. The hard carbon anode material prepared by the disclosure has a reversible capacity of no less than 330 mAh/g, excellent cycle stability and initial coulomb efficiency.

### TECHNICAL FIELD

The present disclosure belongs to the technical field of sodium ion battery materials, and particularly relates to a preparation method of a hard carbon anode material and use thereof.

### BACKGROUND

With the popularization of new energy vehicles, the consumption of lithium ion batteries has increased sharply. Accordingly, nickel, cobalt and manganese, which are important resources in the lithium batteries, are gradually in short supply, and their prices have gradually increased. In order to relieve the pressure of mining mineral resources, sodium ion batteries with similar charging and discharging mechanisms to the lithium batteries have attracted people's attention again. Sodium salts are distributed all over the world, which can effectively relieve the pressure caused by the shortage of the nickel, cobalt and manganese resources. However, the anode graphite commonly used in the lithium ion batteries, is not suitable for sodium ion batteries, because the diameter of sodium ions is larger than that of lithium ions, which makes it impossible to deintercalate between graphite layers. In addition, the sodium ions cannot form a stable phase structure with the graphite. Other anode materials of the sodium ion batteries have also been studied at the same time, comprising graphitized hard carbon, alloys, oxides and organic compounds. However, at present, most anode materials will have a large volume expansion in the process of sodium ion intercalation, resulting in irreversible capacity decay.

### SUMMARY

The present disclosure aims at solving at least one of the above-mentioned technical problems in the prior art. Therefore, the present disclosure provides a preparation method of a hard carbon anode material and use thereof. The hard carbon anode material prepared by the preparation method has a reversible capacity of no less than 350 mAh/g, excellent cycle stability and initial coulomb efficiency.

In order to achieve the above object, the following technical solutions is used in the present disclosure.

A preparation method of a hard carbon anode material, includes the following steps of:
(1) performing first sintering on starch, crushing, and introducing air and nitrogen for secondary sintering to obtain porous hard block granules; and
(2) performing third sintering on the porous hard block granules, and then continuously warming up to perform fourth sintering to obtain the hard carbon anode material.

For the step of introducing air and nitrogen for secondary sintering: the oxygen concentration in the air is about 20.7%, and after being compressed by an air compressor, the oxygen concentration is about 16%. In the present disclosure, the nitrogen and the air are introduced at the same time to dilute the oxygen concentration in the air, so that the oxygen concentration can be controlled. Controlling the oxygen concentration in a proper range, on one hand, the safety problem in the sintering process is improved, and on the other hand, oxygen molecules are introduced to make the oxygen molecules fully react. Part of the oxygen molecules reacts with carbon to form oxygen-containing functional groups as active sites, while another part of the oxygen molecules react with part of the carbon to form CO and CO₂, which leads to the formation of pores on the surface and inside of the material. The pores contribute to the storage of sodium ions and thus improve electrochemical performances of the material.

Preferably, in step (1), the starch is at least one selected from the group consisting of corn starch, mung bean starch, potato starch, wheat starch, tapioca starch or lotus root starch.

Preferably, in step (1), the first sintering is performed in a nitrogen atmosphere.

Preferably, in step (1), the first sintering is performed at a temperature of 180° C. to 240° C., and the first sintering lasts for 8 hours to 48 hours.

The first sintering is performed in the nitrogen atmosphere to make hydrogen bonds between glucose chains in the starch be broken to generate ether bonds and cause a cross-linking reaction, which makes the chemical structure of the hard solids stable, and may not be pyrolyzed and expanded at a higher temperature.

Preferably, in step (1), a volume content of the oxygen in the secondary sintering is 4% to 10%.

Preferably, in step (1), the secondary sintering is performed at a temperature of 200° C. to 250° C., and the secondary sintering lasts for 3 hours to 12 hours.

The secondary sintering is performed under the oxygen:

2C+O₂=2CO; and

C+O₂=CO₂.

In the secondary sintering process, the oxygen molecules fully react with the material to form the oxygen-containing functional groups as the active sites, and at the same time, the oxygen reacts with some carbon to form CO and CO₂, which leads to the formation of the pores on the surface and inside of the material. The pores contribute to the storage of the sodium ions and thus improve the electrochemical performances of the material.

Preferably, in step (2), before the third sintering, the method further comprises the step of crushing the porous hard block granules to granules with a particle size Dv50 of 5 μm to 6 μm.

Preferably, in step (2), the third sintering is performed at a temperature of 400° C. to 500° C., and the third sintering lasts for 2 hours to 4 hours.

Preferably, in step (2), the third sintering is performed in a nitrogen atmosphere.

In the third sintering process, the porous hard solids are aromatic-cyclized.

Preferably, in step (2), the fourth sintering is performed at a temperature of 1,200° C. to 1,400° C., and the fourth sintering lasts for 2 hours to 4 hours.

Preferably, in step (2), the fourth sintering is performed in a nitrogen atmosphere.

In the fourth sintering process, the oxygen-containing functional group and bound water of the hard carbon material can be removed, so that the structure can be further rearranged, and the diameter and the specific surface area of the pores caused by low-oxygen sintering can be reduced. Excessive pores and specific surface area may lead to excessive SEI films and thus reduce the initial coulomb efficiency.

Preferably, in step (2), the hard carbon anode material has a particle size Dv50 of 4 μm to 6 μm, and a Dv90 of 9 μm to 12 μm.

A hard carbon anode material, which is prepared by the above-mentioned method, and has a reversible capacity no less than 330 mAh/g.

Preferably, the main component of the hard carbon anode material is C, which is one of amorphous carbons, but is difficult to graphitize at a high temperature above 2500° C. The morphology of the hard carbon anode material is a block granule with a smooth edge.

Preferably, the hard carbon anode material has a specific surface area of 0.8 m²/g to 1.2 m²/g, a Dv50 of 4 μm to 6 μm, and a Dv90 of 9 μm to 12 μm.

A sodium ion battery, comprises the hard carbon anode material prepared by the preparation method above.

Preferably, the sodium ion battery further comprises sodium carboxymethyl cellulose, a conductive agent and a binder.

Further preferably, the conductive agent is acetylene black.

Further preferably, the binder is polyvinylidene fluoride.

Compared with the prior art, the present disclosure has the following beneficial effects.

(1) According to the present disclosure, the starch is used as the raw material of the hard carbon anode material, and after four times of sintering, the hydrogen bonds between the glucose chains in the starch are broken to generate the ether bonds and cause the cross-linking reaction. Then, the secondary sintering is performed in an oxygen-containing atmosphere, in which the oxygen molecules fully react with the material to form the oxygen-containing functional groups as the active sites, and at the same time, the oxygen reacts with some carbon to form CO and CO₂, which leads the formation of the pores on the surface and inside of the material. The pores contribute to the storage of the sodium ions and thus improve the electrochemical performances of the material. Then, the third sintering is continued to make the porous hard solids be aromatic-cyclized. Finally, in the fourth sintering process, the oxygen-containing functional groups and bound water of the hard carbon materials are removed, so that the structure is further rearranged, the diameter and the specific surface area of the pores caused by low-oxygen sintering can be reduced, and the initial coulomb efficiency is improved. The hard carbon anode material prepared by the present disclosure has the reversible capacity of no less than 330 mAh/g, and the initial coulomb efficiency no less than 88%.

(2) The multi-stage sintering method of the present disclosure can prepare high-performance hard carbon materials, and the synthesis method of the present disclosure is simple and easy to operate. The raw material is starch, which has a wide source and is cheaper than the sugar and cellulose raw materials commonly used at present.

### BRIEF DESCRIPTION OF THE DRAWINGS

FIG. 1 is the SEM graph of the hard carbon anode material prepared in Example 1 of the present disclosure;

FIG. 2 is the aperture distribution graph of the hard carbon anode material prepared in Example 1 of the present disclosure;

FIG. 3 is the XRD graph of the hard carbon anode material prepared in Example 1 of the present disclosure; and

FIG. 4 is the charge-discharge curve of the hard carbon anode material in Example 2 of the present disclosure.

### DETAILED DESCRIPTION

The concepts and the technical effects produced of the present disclosure will be clearly and completely described in conjunction with the embodiments and the accompanying drawings so as to sufficiently understand the objects, the features and the effects of the present disclosure. Obviously, the described embodiments are merely some embodiments of the present disclosure, rather than all the embodiments. Other embodiments obtained by those skilled in the art without going through any creative effort shall all fall within the protection scope of the present disclosure.

### Example 1

The preparation method of the hard carbon anode material of this example, comprised the following steps.
(1) weighing 500 g of corn starch, and placing the corn starch in a 220° C. low-temperature furnace under the nitrogen atmosphere for first sintering for 8 hours to cause a cross-linking reaction and obtain hard solids;
(2) crushing the hard solids, placing the hard solids in a 205° C. low-temperature furnace introduced with nitrogen and compressed air for secondary sintering for 12 hours, and keeping the oxygen content in the furnace at 5% to obtain porous black granules; and
(3) crushing the porous black granules into powders with Dv50 of 5 μm of 6 μm, placing the powders in the nitrogen atmosphere for the third sintering at 400° C. for 2 hours first, and then warming up to 1,400° C. for the fourth sintering for 2 hours to obtain the hard carbon anode material.

The hard carbon anode material of Example 1, sodium carboxymethyl cellulose, an acetylene black conductive agent and a PVDF (polyvinylidene fluoride) binder were dissolved in deionized water at the mass ratio of 95:2:1:2 to prepare slurry. The slurry was then coated on a copper foil to obtain an electrode plate, and then the electrode plate was dried in a drying cabinet at 80° C. for 8 hours. Finally, a button battery was assembled in a glove box filled with argon atmosphere. The electrolyte used was prepared by dissolving NaClO₄ in ethylene carbonate and propylene carbonate in the volume ratio of 1:1, and a sodium metal foil was used as a counter electrode and a reference electrode.

FIG. 1 is the SEM graph of the hard carbon anode material of Example 1. It could be seen from the figure that the morphology of the material was a block granule with smooth edge.

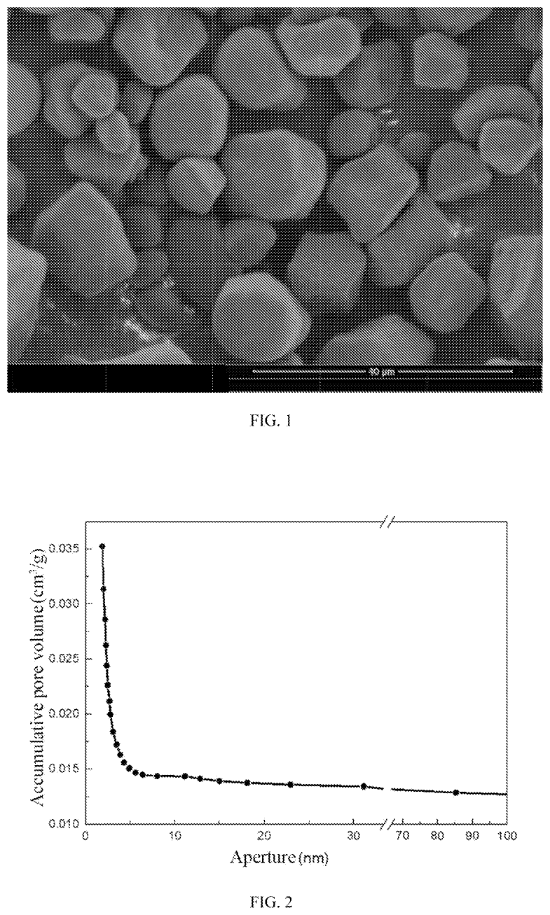

FIG. 2 is the aperture distribution graph of the hard carbon anode material of Example 1. It could be seen from the figure that the pore width in the material was concentrated below 3 nm.

FIG. 3 is the XRD graph of the hard carbon anode material of Example 1. It could be seen from the figure that the diffraction peak (002) had a larger half-peak width and a smaller angle, which indicated that the disorder degree of the material was higher, and the interlayer spacing was larger.

### Example 2

The preparation method of the hard carbon anode material of this example, comprised the following steps.
(1) weighing 500 g of corn starch, and placing the corn starch in a 220° C. low-temperature furnace under the nitrogen atmosphere for first sintering for 8 hours to cause a cross-linking reaction and obtain hard solids;
(2) crushing the hard solids, placing the hard solids in a 205° C. low-temperature furnace introduced with nitrogen and compressed air for secondary sintering for 12 hours, and keeping the oxygen content in the furnace at 7% to obtain porous black granules; and
(3) crushing the porous black granules into powders with Dv50 of 5 μm of 6 μm, placing the powders in the nitrogen atmosphere for the third sintering at 400° C. for 2 hours first, and then warming up to 1,400° C. for the fourth sintering for 2 hours to obtain the hard carbon anode material.

The hard carbon anode material of Example 2, sodium carboxymethyl cellulose, an acetylene black conductive agent and a PVDF (polyvinylidene fluoride) binder were dissolved in deionized water at the mass ratio of 95:2:1:2 to prepare slurry. The slurry was then coated on a copper foil to obtain an electrode plate, and then the electrode plate was dried in a drying cabinet at 80° C. for 8 hours. Finally, a button battery was assembled in a glove box filled with argon atmosphere. The electrolyte used was prepared by dissolving NaClO₄ in ethylene carbonate and propylene carbonate in the volume ratio of 1:1, and a sodium metal foil was used as a counter electrode and a reference electrode.

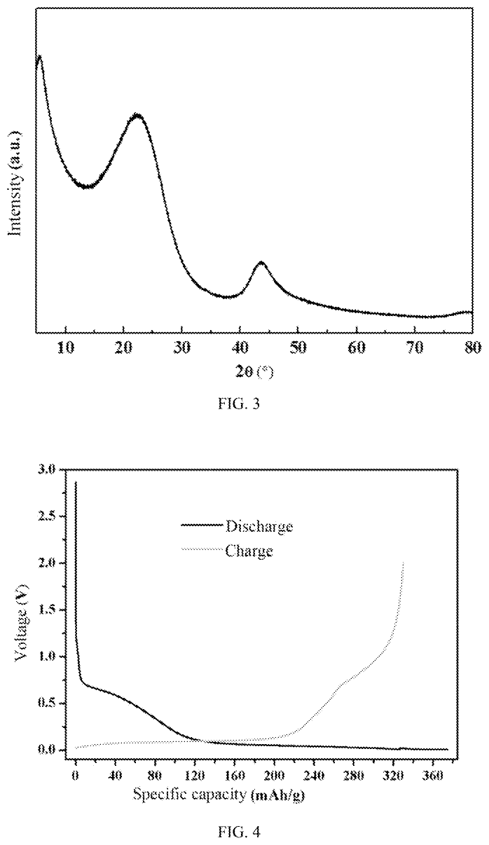

FIG. 4 is the charge-discharge curve of the hard carbon anode material in Example 2 of the present disclosure. It could be seen from the figure that the specific charge capacity of the material was as high as 336.7 mAh/g, and the initial efficiency was as high as 88.19%, indicating that the hard carbon anode material prepared in Example 2 had high reversible capacity and initial efficiency.

### Example 3

The preparation method of the hard carbon anode material of this example, comprised the following steps.
(1) weighing 500 g of corn starch, and placing the corn starch in a 220° C. low-temperature furnace under the nitrogen atmosphere for first sintering for 8 hours to cause a cross-linking reaction and obtain hard solids;
(2) crushing the hard solids, placing the hard solids in a 205° C. low-temperature furnace introduced with nitrogen and compressed air for secondary sintering for 12 hours, and keeping the oxygen content in the furnace at 9% to obtain porous black granules; and
(3) crushing the porous black granules into powders with Dv50 of 5 μm of 6 μm, placing the powders in the nitrogen atmosphere for the third sintering at 400° C. for 2 hours first, and then warming up to 1,400° C. for the fourth sintering for 2 hours to obtain the hard carbon anode material.

The hard carbon anode material of Example 3, sodium carboxymethyl cellulose, an acetylene black conductive agent and a PVDF (polyvinylidene fluoride) binder were dissolved in deionized water at the mass ratio of 95:2:1:2 to prepare slurry. The slurry was then coated on a copper foil to obtain an electrode plate, and then the electrode plate was dried in a drying cabinet at 80° C. for 8 hours. Finally, a button battery was assembled in a glove box filled with argon atmosphere. The electrolyte used was prepared by dissolving NaClO₄ in ethylene carbonate and propylene carbonate in the volume ratio of 1:1, and a sodium metal foil was used as a counter electrode and a reference electrode.

### Comparative Example 1 (without Third and Fourth Sintering)

The preparation method of the hard carbon anode material of this comparative example, comprised the following steps.
(1) weighing 500 g of corn starch, and placing the corn starch in a 220° C. low-temperature furnace under the nitrogen atmosphere for first sintering for 8 hours to cause a cross-linking reaction and obtain hard solids; and
(2) crushing the hard solids, placing the hard solids in a 205° C. low-temperature furnace introduced with nitrogen and compressed air for secondary sintering for 12 hours, and keeping the oxygen content in the furnace at 5% to obtain the hard carbon anode material.

The hard carbon material of Comparative Example 1, sodium carboxymethyl cellulose, an acetylene black conductive agent and a PVDF (polyvinylidene fluoride) binder were dissolved in deionized water at the mass ratio of 95:2:1:2 to prepare slurry. The slurry was then coated on a copper foil to obtain an electrode plate, and then the electrode plate was dried in a drying cabinet at 80° C. for 8 hours. Finally, a button battery was assembled in a glove box filled with argon atmosphere. The electrolyte used was prepared by dissolving NaClO₄ in ethylene carbonate and propylene carbonate in the volume ratio of 1:1, and a sodium metal foil was used as a counter electrode and a reference electrode.

### Comparative Example 2 (without Aerobic Sintering)

The preparation method of the hard carbon anode material of this comparative example, comprised the following steps.
(1) weighing 500 g of corn starch, and placing the corn starch in a 220° C. low-temperature furnace under the nitrogen atmosphere for sintering for 8 hours to cause a cross-linking reaction and obtain hard solids; and
(2) crushing the hard solids into powders with Dv50 of 5 μm of 6 μm, placing the powders in the nitrogen atmosphere for the secondary sintering at 400° C. for 2 hours first, and then warming up to 1,400° C. for the third sintering for 2 hours to obtain the hard carbon anode material.

The hard carbon material of Comparative Example 2, sodium carboxymethyl cellulose, an acetylene black conductive agent and a PVDF (polyvinylidene fluoride) binder were dissolved in deionized water at the mass ratio of 95:2:1:2 to prepare slurry. The slurry was then coated on a copper foil to obtain an electrode plate, and then the electrode plate was dried in a drying cabinet at 80° C. for 8 hours. Finally, a button battery was assembled in a glove box filled with argon atmosphere. The electrolyte used was prepared by dissolving NaClO₄ in ethylene carbonate and propylene carbonate in the volume ratio of 1:1, and a sodium metal foil was used as a counter electrode and a reference electrode.

Physicochemical Performances:

Table 1 showed the comparison of specific surface areas between the samples prepared in Examples 1, 2 and 3 and Comparative Examples 1 and 2, finding that with the increase of the oxygen content in the sintering process, the specific surface area of the material increased slightly, while the carbonization process rearranged the structure of the material, filled the pores and reduced the specific surface area. The specific surface area of Comparative Example 1 was too large because the carbon material was not aromatic-cyclized and carbonized. The specific surface area of the hard carbon material in Comparative Example 2 was very low since the aerobic sintering was not conducted.

TABLE 1
Test data of the specific surface areas of the hard carbon materials
prepared in Examples 1, 2 and 3 and Comparative Examples 1 and 2

| Sample | Specific surface area (m²/g) |
|---|---|
| Example 1 | 0.83 |
| Example 2 | 1.02 |
| Example 3 | 1.17 |
| Comparative Example 1 | 18.16 |
| Comparative Example 2 | 0.15 |

Electrochemical Performances:

Table 2 showed the comparison between of electrochemical performances between the samples prepared in Examples 1, 2 and 3 and Comparative Examples 1 and 2, finding that with the increase of the oxygen content in the sintering process, both the specific capacity and the initial efficiency of the prepared materials increased, but the excessive specific surface area leaded to a large increase of SEI films, which leaded to the decrease of the specific capacity and the initial efficiency.

TABLE 2
Test data of electrochemical performances of hard carbon materials
prepared in Examples 1, 2 and 3 and Comparative Examples 1 and 2

| | Specific charge capacity | Coulomb efficiency |
|---|---|---|
| Sample | (mAh g⁻¹) | (%) |
| Example 1 | 331.2 | 85.75 |
| Example 2 | 336.7 | 88.19 |
| Example 3 | 337.1 | 86.29 |
| Comparative Example 1 | 269.2 | 66.12 |
| Comparative Example 2 | 285.3 | 74.69 |

The present disclosure is not limited to the above embodiments, and various changes can be made within the knowledge of those of ordinary skills in the art without departing from the objective of the present disclosure. In addition, in case of no conflict, the embodiments in the present disclosure and the features in the embodiments may be combined with each other.

1. A preparation method of a hard carbon anode material, comprising the following steps of:
(1) performing first sintering on starch, crushing, and introducing air and nitrogen for secondary sintering to obtain porous hard block granules; and
(2) performing third sintering on the porous hard block granules, and then continuously warming up to perform fourth sintering to obtain the hard carbon anode material; wherein,
in step (1), the first sintering is performed at a temperature of 180° C. to 240° C., the first sintering lasts for 8 hours to 48 hours, and the first sintering is performed in a nitrogen atmosphere;
the secondary sintering is performed at a temperature of 200° C. to 250° C., and the secondary sintering lasts for 3 hours to 12 hours, and a volume content of oxygen in an atmosphere of the secondary sintering is 4% to 10%;
in step (2), the third sintering is performed at a temperature of 400° C. to 500° C., the third sintering lasts for 2 hours to 4 hours, and the third sintering is performed in a nitrogen atmosphere; and
the fourth sintering is performed at a temperature of 1,200° C. to 1,400° C., and the fourth sintering lasts for 2 hours to 4 hours.

2. The preparation method according to claim 1, wherein in step (1), the starch is at least one selected from the group consisting of corn starch, mung bean starch, potato starch, wheat starch, tapioca starch and lotus root starch.

3-7. (canceled)

8. A hard carbon anode material prepared by the preparation method according to claim 1, wherein the hard carbon anode material has a reversible capacity of no less than 330 mAh/g.

9. The hard carbon anode material according to claim 8, wherein the hard carbon anode material has a specific surface area of 0.8 m²/g to 1.2 m²/g, a Dv50 of 4 μm to 6 μm, and a Dv90 of 9 μm to 12 μm.

10. A sodium ion battery comprising the hard carbon anode material according to claim 8.

11. A sodium ion battery comprising the hard carbon anode material according to claim 9.

12. A hard carbon anode material prepared by the preparation method according to claim 2, wherein the hard carbon anode material has a reversible capacity of no less than 330 mAh/g.

13. The hard carbon anode material according to claim 12, wherein the hard carbon anode material has a specific surface area of 0.8 m²/g to 1.2 m²/g, a Dv50 of 4 μm to 6 μm, and a Dv90 of 9 μm to 12 μm.

14. A sodium ion battery comprising the hard carbon anode material according to claim 12.

15. A sodium ion battery comprising the hard carbon anode material according to claim 13.
